(19) United States
(12) Patent Application Publication
(10) Pub. No.: US 2022/0324171 A1
(43) Pub. Date: Oct. 13, 2022

(54) SPOOL FOR SUPPORTING A FILAMENT AND FILAMENT SPOOL

(71) Applicant: Covestro (Netherlands) B.V., Nieuwegein (NL)

(72) Inventors: Felix NEUMANN, Geleen (NL); Maurice DALPIAZ, Geleen (NL); Paul KUPKA, Geleen (NL); Tim HOLTRICH, Geleen (NL)

(21) Appl. No.: 17/634,266

(22) PCT Filed: Aug. 13, 2020
(86) PCT No.: PCT/EP2020/072805

§ 371 Date: Feb. 10, 2022

(30) Foreign Application Priority Data
Aug. 16, 2019 (EP) 19192104.8

(51) Int. Cl. B29C 64/255; B29C 64/118; B33Y 30/00

(52) U.S. Cl. CPC B29C 64/255; B29C 64/118; B33Y 30/00

(57) ABSTRACT

The invention refers to a spool (10) for supporting a filament (90), comprising a first flange (21), a second flange (22) and a connector (30), the connector (30) connecting the first flange (21) and the second flange (22) and defining a winding surface (40) for winding the filament (90) about a winding axis (X). Thereat, a plurality of openings (33) is provided in the connector (30), the openings (33) running in radial direction (R). The invention also refers to a filament spool (80), comprising a spool (10) according to the invention and a filament (90), in particular a thermoplastic filament (90) for use in a 3D printer, the filament (90) being winded thereon.

### FIELD OF THE INVENTION

The invention relates to a spool for supporting a filament, in particular for supporting a thermoplastic filament for use in a 3D printer. The spool comprises a first flange, a second flange and a connector connecting the first flange and the second flange. The connector defines a winding surface for winding the filament thereon about a winding axis. The invention also relates to a filament spool, comprising a spool and a filament, in particular a thermoplastic filament for use in a 3D printer, whereat the filament is winded on said spool.

### CROSS-REFERENCE TO RELATED APPLICATIONS

This application claims priority to European patent application number EP19192104.8, filed on 16 Aug. 2019, the entire content of which is hereby incorporated by reference in its entirety as if fully set forth herein.

### STATE OF THE ART

In three-dimensional (3D) printers, thermoplastic filaments are used. Said filaments are produced in extruders at relatively high temperature. After production, the filaments are cooled down and are winded onto spools for storage and shipment. A generic spool comprises a cylindrical centre portion that defines a winding surface for winding the filament about a winding axis. A generic spool further comprises two flanges that are arranged at each front end of the cylindrical centre portion. Hence, the filament is surrounded in axial direction by the flanges that prevent the filament from leaving the cylindrical centre portion in axial direction.

The document CN 108357988 A discloses a spool for holding 3D printing filament. The spool includes flanges having holes connected by a central cylindrical support. The support is surrounded by radially extending sheets. The spool also includes a label to identify the type of filament. The flanges are configured to be attached to the central cylindrical support.

The document WO 2018/005459 A1 discloses a spool assembly for holding a thermoplastic filament. Thereat, the spool assembly is formed with flanges separated by a central member. The spool assembly is provided with a moisture absorbing material.

The document CN107932913 A discloses a winding mechanism for a consumable for a 3D printer. Within said mechanism, spools with flanges having holes formed therein are used.

The document CN203682776 U discloses a spool with flanges having holes formed therein.

The document US 2017/0166415 A1 discloses a sealing apparatus comprising a moisture barrier that engages with a filament spool to create a moisture-resistant enclosure for housing a filament on said spool.

The document US 2013/0292881 A1 discloses build materials for use in colour-controlled 3D printing and a 3D printer. Filaments made of such materials can be fed to a chamber of an extruder of the 3D printer.

The document US 2013/0000831 A1 discloses a spool including a tubular member to receive a stranded material wrapped there around. The tubular member is arranged between a first flange and a second flange.

The document US 2010/0096489 A1 discloses a filament spool for use in a filament spool container. The filament spool comprises a first rim and a second rim offset by an axial shaft and a filament which is wound around the axial shaft in a first rotational direction.

The document WO 2015/019212 A1 discloses a polymeric material as a support material in a 3D printer system. The polymeric material is shaped as a filament and is winded onto a spool.

KR 2016118605 A discloses a spool installing apparatus for 3D printers which stores a spool for supplying filament materials. The spool installing apparatus comprises a spool storage unit whose main body is formed such that a spool can be installed inside the 3D printer and which includes a storage rod in the centre of the main body for coupling with a central hole of the spool.

Also, the documents CN 207172751 U, CN 107756802 A, CN 206884173 U, CN 205326297 U, CN 105500712 A, CN 204324603 U and CN 204150805 U disclose spools for supporting a filament.

When the filament is winded onto the spool, the filament still has a temperature higher than ambient temperature. Furthermore, the filament often is hydrophilic. Typical polymers to be used are polyamides, polylactic acid (PCA), ABS-copolymers, ASA, PET and polycarbonate (PC). Hence, during storage, the filament can absorb moisture dependent on air humidity. However, in use in a 3D printer, moisture within the filament may cause difficulties during a printing process. In particular, moisture within the filament reduces quality of a 3D print.

### DESCRIPTION OF THE INVENTION

It is an object of the invention to provide a spool for supporting a filament that improves drying and cooling of the filament winded thereon. Said object is solved by means of a spool for supporting a filament with the features of claim 1.

The spool comprises a first flange, a second flange and a connector. The connector is arranged between the first flange and the second flange. Thereat, the connector connects the first flange and the second flange. Furthermore, the connector defines a winding surface for winding the filament about a winding axis.

According to the invention, a plurality of openings is provided in the connector of the spool. Thereat, the connector is shaped such that said openings are running in radial direction in respect to the winding axis. The radial direction extends perpendicular to the winding axis.

The spool according to the invention enables accelerated cooling and drying of the filament winded thereon. The openings provided in the connector increase an outer surface of the filament which is in contact with ambient air. Hence, ambient air has a greater surface to pass the filament and hence removal of thermal energy and moisture from the filament is accelerated.

When the filament is free of moisture, the user gains a better quality of a 3D print and can use more types of material for printing. Advantageously, the spool is refillable with another filament, once the filament winded thereon is spent. Hence, waste is reduced and costs are saved.

According to an advantageous embodiment of the invention, the flanges and/or the connector are made of a glass fibre reinforced material. Hence, the heat resistance of the spool, at least of the flanges and/or of the connector, is raised. Furthermore, the production of the flanges and/or the connector made of a glass fibre reinforced material is not difficult.

The flanges and/or the connectors can also be made of a material, in particular a polymer, reinforced or filled with glass, mineral, carbon or other fibres or fillers.

According to another advantageous embodiment of the invention, the flanges and/or the connector are made of a thermoplastic material.

Preferably, the connector comprises a fixation element for fixing a first end of the filament. Thereat, the first end of the filament is the end which is located in proximity of the winding surface of the connector, which means in radial direction inside, close to the winding axis.

According to another possible embodiment of the invention, a hole or an aperture is arranged in the first flange and/or in the second flange of the spool. Said hole or aperture is arranged such that the first end of the filament can protrude therethrough. Thus, the first end of the filament is fixed by said hole or aperture.

According to a preferred embodiment of the invention, a plurality of apertures is provided in the first flange and in the second flange. Thereat, the flanges are shaped such that said apertures are running in axial direction in respect to the winding axis. The axial direction extends parallel to the winding axis. The apertures in the flanges further increase the outer surface of the filament which is in contact with ambient air. Hence, ambient air may contact an increased surface of the filament. Hence, removal of thermal energy and moisture from the filament is accelerated.

According to a possible embodiment of the invention, a clip is provided for fixing a second end of the filament on the spool. Thereat, the clip is fixed in one of the apertures of the first flange and/or of the second flange. The second end of the filament is the end which is located averted from the winding surface of the connector, which means in radial direction outside, on the far side of the winding axis. Advantageously, the clip is labelled with name and type of the filament that is winded on the spool.

According to another possible embodiment of the invention, a clip is provided for fixing a second end of the filament on the spool. Thereat, the clip is fixed at an outer circumference of the first flange and/or of the second flange. The second end of the filament is the end which is located averted from the winding surface of the connector, which means in radial direction outside, on the far side of the winding axis. Advantageously, the clip is labelled with name and type of the filament that is winded on the spool.

Alternatively or additionally to the labelled clip, a chip is included in the spool, in particular in the first flange and/or of the second flange. For example, the clip is designed as a NFC (Near File Communication) chip. The chip contains information with name and type of the filament that is winded on the spool. The 3D-printer can read the information stored on the chip.

According to a preferred embodiment of the invention, the first flange and the second flange of the spool are shaped identically. Thus, only one kind of flange needs to be produced which simplifies production and supply of the flanges.

According to an advantageous embodiment of the invention, the connector is fixed to the first flange and to the second flange by a bayonet catch. Thus, assembly of the spool is advantageously simplified. Also, disassembly of the spool is possible without destruction of the connector or the flanges. Preferably, the bayonet catch is shaped such that assembly of the spool is possible only in one specified formation. Hence, it is ensured that the flanges have the same and correct orientation after being attached to the connector.

According to an advantageous further development of the invention, the connector comprises a plurality of ribs. Thereat, the ribs extend essentially in radial direction and in axial direction in respect to the winding axis. By means of said ribs and said kind of orientation of said ribs, mechanical stability of the connector and of the spool is enhanced.

Preferably, the ribs are arranged equidistant in circumferential direction in respect to the winding axis. The circumferential direction extends circular around the winding axis and perpendicular to the radial direction.

According to a preferred embodiment of the invention, the ribs of the connector are arranged such that the ribs and the openings are arranged alternatingly in circumferential direction. Thus, each rib is surrounded by two openings and each opening is surrounded by two ribs.

According to an advantageous embodiment of the invention, the connector comprises a first end portion that is connected to the first flange, and the connector also comprises a second end portion that is connected to the second flange. As mentioned already, the end portions of the connector are fixed to the first flange and to the second flange by a bayonet catch, preferably. Thereat, the ribs of the connector connect the first end portion and the second end portion.

According to a preferred embodiment of the invention, outer end faces of the ribs define the winding surface for winding the filament about the winding axis in circumferential direction in respect to the winding axis. The outer end faces of the ribs are the end faces that are averted from the winding axis. The radial direction is perpendicular to the outer end faces of the ribs.

According to an advantageous embodiment of the invention the connector is shaped one-piece. Hence, when assembling the spool, a separate assembly of the connector is not necessary.

It is a further object of the invention to provide filament spool comprising a filament, in particular a thermoplastic filament, for use in a 3D printer, and a spool that improves drying and cooling of the filament winded thereon. Said object is solved by means of a filament spool with the features of claim 16.

A filament spool according to the invention comprises a spool according to the invention as described above and a filament, in particular a thermoplastic filament for use in a 3D printer. Thereat, the filament is winded on the spool. The filament spool according to the invention is functional and easy to use. The filament may also be a metal or ceramic loaded thermoplastic.

### BRIEF DESCRIPTION OF THE DRAWINGS

Further details, embodiments and advantages of the present invention will become apparent from the following detailed description, which is provided by way of example only, with reference to the drawings, wherein:

FIG. 1 is a three-dimensional view of a spool for supporting a filament,

FIG. 2 is a three-dimensional view of a flange of the spool shown in FIG. 1,

FIG. 3 is a three-dimensional view of a connector of the spool shown in FIG. 1, and

FIG. 4 is a three-dimensional view of a filament spool comprising the spool shown in FIG. 1.

Hereinafter, preferred embodiments of the present invention will be described with reference to the drawings. The drawings only provide schematic views of the invention. Like reference numerals refer to corresponding parts, elements or components throughout the figures, unless indicated otherwise.

### DETAILED DESCRIPTION

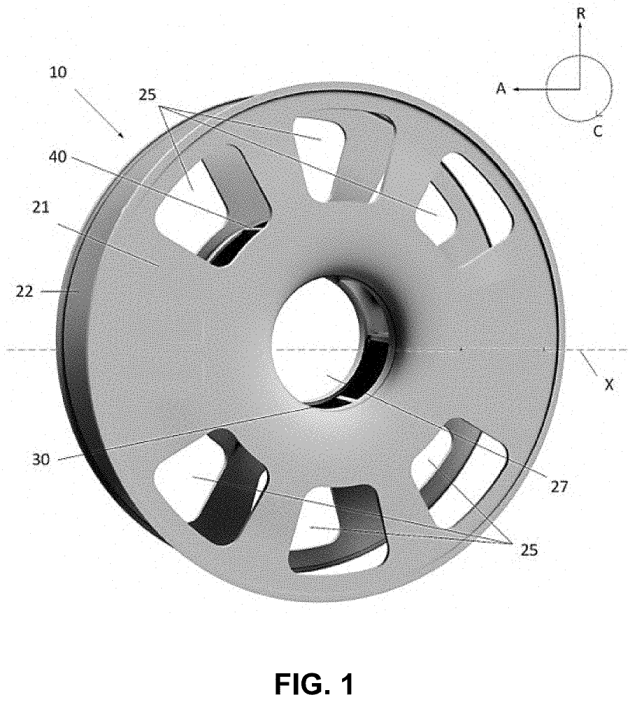

FIG. 1 is a three-dimensional view of a spool 10 for supporting a filament 90 which is not shown here. The spool 10 comprises a first flange 21 and a second flange 22 that are arranged parallel to each other and spaced apart. The spool 10 further comprises a connector 30 that is arranged between the first flange 21 and the second flange 22. The connector 30 connects the first flange 21 and the second flange 22. The connector 30 defines a winding surface 40 for winding the filament 90 about a winding axis X.

In the following, cylindrical coordinates are used to describe directions and positions. Thereat, an axial direction A extends parallel to the winding axis X. A radial direction R extends perpendicular to the winding axis X. A circumferential direction C extends circular around the winding axis X and hence extends perpendicular to the radial direction R.

The first flange 21 and the second flange 22 of the spool 10 are shaped identically. The flanges 21, 22 have a circular profile whereat the centre lines of said circular profiles align with each other and with the winding axis X. The flanges 21, 22 each contain a central bore 27 which serve for mounting the spool 10 rotatable in a 3D printer. The bores 27 are running in axial direction A. The winding axis X extends through centres of the bores 27.

The flanges 21, 22 also each contain a plurality of apertures 25. Said apertures 25 are running in axial direction A. In radial direction R, the apertures 25 are arranges in areas of the flanges 21, 22 that are averted from the winding axis X. The apertures 25 are not mandatorily distributed equidistant in circumferential direction C. The flanges 21, 22 are arranged such that the apertures 25 in the first flange 21 align with the apertures 25 in the second flange 22.

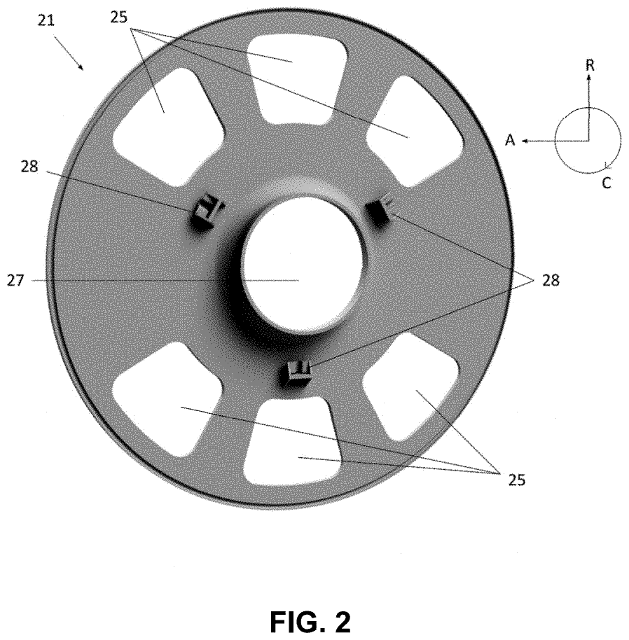

FIG. 2 is a three-dimensional view of the first flange 21 of the spool 10 shown in FIG. 1. Thereat, that side of the first flange 21 is shown which is directed towards the connector 30 when assembled in the spool 10. As mentioned already, the second flange 22 of the spool 10 shown in FIG. 1 is shaped identically to the first flange 21. As described above, the first flange 21 contains the central bore 27 and a plurality of apertures 25. The first flange 21 is made of a glass fibre reinforced material and hence is heat resistant.

The first flange 21 further comprises detents 28. The detents 28 are shaped on-piece with the remaining first flange 21. In radial direction R, the detents 28 are arranged in an area between the central bore 27 and the apertures 25. The detents 28 serve for connecting the connector 30. Thereat, three detents 28 are provided that are arranged equidistant in circumferential direction C.

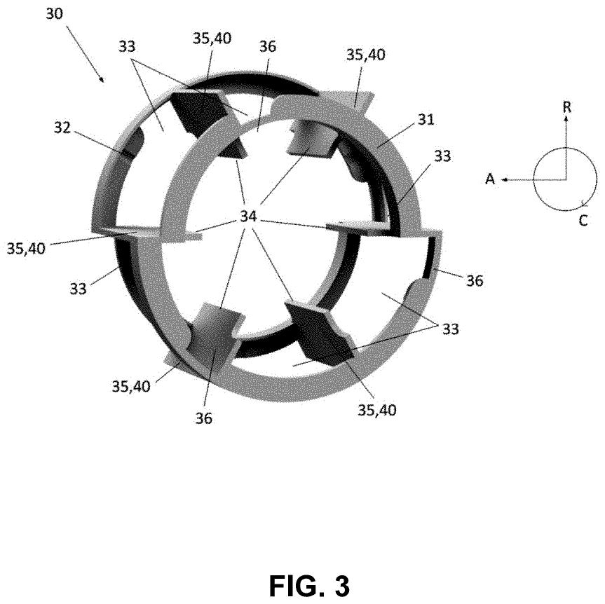

FIG. 3 is a three-dimensional view of the connector 30 of the spool 10 shown in FIG. 1. The connector 30 is made of a glass fibre reinforced material and hence is heat resistant, like the flanges 21, 22 are. Thereat, the connector 30 is shaped one-piece.

The connector 30 comprises a first end portion 31 and a second end portion 32. The first end portion 31 and a second end portion 32 are arranged spaced apart in axial direction A. When assembled to the spool 10 shown in FIG. 1, the first end portion 31 is connected to the first flange 21, and the second end portion 32 is connected to the second flange 22.

Within the end portions 31, 32 of the connector 30, notches 36 are provided. The notches 36 serve for connecting the end portions 31, 32 to the flanges 21, 22. The notches 36 are shaped as to interact with the detents 28 of the flanges 21, 22. Thereat, three notches 36 are provided in each end portion 31, 32 that are arranged equidistant in circumferential direction C.

The notches 36 of the connector 30 and the detents 28 of the flanges 21, 22 form a bayonet catch. Hence, the end portions 31, 32 of the connector 30 are fixed to the flanges 21, 22 by a bayonet catch. Said bayonet catch is shaped such that assembly of the spool 10 is possible only in one specified formation of the flanges 21, 22 in relation to the connector 30.

The connector 30 also comprises a plurality of ribs 34. The ribs 34 extend essentially in radial direction R and in axial direction A. In circumferential direction C, the ribs 34 are shaped relatively thin. Hence, the extension of the ribs 34 in circumferential direction C is smaller than the extension of the ribs 34 in radial direction R and in axial direction A.

The ribs 34 connect the first end portion 31 and the second end portion 32 of the connector 30. Thereat, six ribs 34 are provided that are arranged equidistant in circumferential direction C. Between every two adjacent ribs 34, in each case an opening 33 is provided. Hence, the connector 30 contains six openings 33. The openings 33 are running in radial direction R.

Thus, the ribs 34 of the connector 30 are arranged such that the ribs 34 and the openings 33 are arranged alternatingly in circumferential direction C. That means, each rib 34 is surrounded by two openings 33 and each opening 33 is surrounded by two ribs 34 in circumferential direction C.

The ribs 34 each have outer end faces 35 that are directed outwardly. When assembled to the spool 10, said outer end faces 35 are averted from the winding axis X. The outer end faces 35 of the ribs 34 extend in axial direction A and tangential to the circumferential direction C. Alternatively, the outer end faces 35 may have a circular bending and hence extend in circumferential direction C. The outer end faces 35 extend perpendicular to the radial direction R. The outer end faces 35 of the ribs 34 define the winding surface 40 for winding the filament 90 about the winding axis X in circumferential direction C.

The connector 30 also comprises a fixation element for fixing a first end of the filament 90. Thereat, the first end of the filament 90 is the end which is located in proximity of the winding surface 40 of the connector 30. In the view given here, the fixation element is not visible.

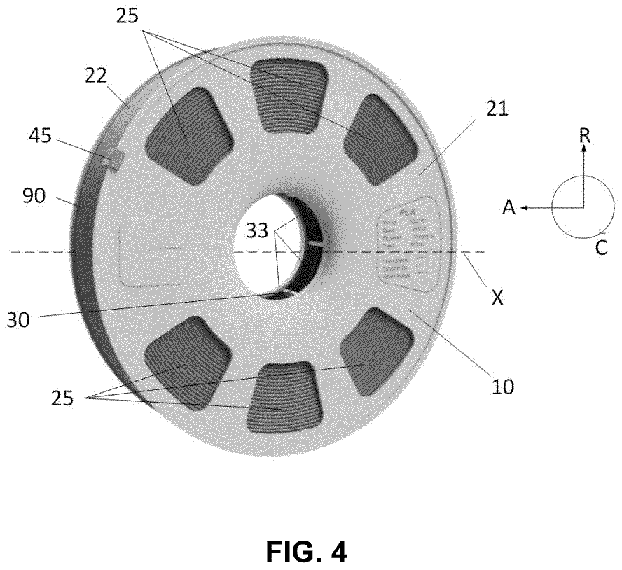

FIG. 4 is a three-dimensional view of a filament spool 80. The filament spool 80 comprises the spool 10 shown in FIG. 1 and a filament 90 which is a thermoplastic filament 90 for use in a 3D printer. The thermoplastic filament 90 is winded on the spool 10 about the winding axis X.

For example, the filament 90 is made of ABS, polycarbonate, glass fibre reinforced PET or potentially cardboard. The filament 90 can also be made of a material, in particular a polymer, reinforced or filled with glass, mineral, carbon or other fibres or fillers. The filament 90 typically has a diameter in the range of 0.5 mm to 8 mm, primarily 1.75 mm and 2.85 mm. Typically, the length of the filament 90 on the spool 10 is in the range of 80 m to 400 m.

Presently, the filament 90 is winded on the winding surface 40 of the connector 30 that is defined by the outer end faces 35 of the ribs 34. Thereat, the first end of the filament 90 is fixed to the connector 30 by means of the fixation element. In axial direction A, the filament 90 is arranged between by the first flange 21 and the second flange 22.

In radial direction R inwardly, towards the winding axis X, the filament 90 touches the openings 33 in the connector 30. In axial direction A, the filament 90 touches the apertures 25 in the first flange 21 and in the second flange 22. In radial direction R outwardly, away from the winding axis X, the filament 90 is exposed completely to ambient air.

The spool 10 comprises a clip 45 for fixing a second end of the filament 90 on the spool 10. Thereat, the clip 45 is fixed at an outer circumference of the first flange 21. Certainly, the clip 45 can also be fixed at an outer circumference of the second flange 22. The second end of the filament 90 is the end which is located averted from the winding surface 40 of the connector 30, that means in radial direction R outside, on the far side of the winding axis X. Here, the clip 45 is labelled with name and type of the filament 90 that is winded on the spool 10.

Alternatively, the spool 10 can comprise a clip 45 which is fixed in one of the apertures 25 of the first flange 21 and/or of the second flange 22. Said clip 45 also serves for fixing the second end of the filament 90 on the spool 10. That clip 45, too, can be labelled with name and type of the filament 90 that is winded on the spool 10.

While the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being defined by the claims appended hereto, taking account of the equivalents thereof.

1. A spool for supporting a filament, comprising
a first flange, a second flange, and a connector, the connector connecting the first flange and the second flange and defining a winding surface for winding the filament about a winding axis,
wherein a plurality of openings is provided in the connector, the openings running in a radial direction.

2. The spool according to claim 1, wherein the first flange, the second flange, the connector, or a combination thereof is made of a glass fibre reinforced material.

3. The spool according to claim 1, wherein the first flange, the second flange, the connector, or a combination thereof is made of a thermoplastic material.

4. The spool according to claim 1, wherein the connector comprises a fixation element for fixing a first end of the filament.

5. The spool according to claim 1, further comprising a plurality of apertures in the first flange and in the second flange,
the apertures running in an axial direction.

6. The spool according to claim 5, further comprising a clip for fixing a second end of the filament, the clip being fixed in one of the apertures of the first flange and/or the second flange.

7. The spool according to claim 1, further comprising a clip for fixing a second end of the filament, the clip being fixed at an outer circumference of the first flange and/or the second flange.

8. The spool according to claim 1, wherein the first flange and the second flange are shaped identically.

9. The spool according to claim 1, wherein the connector is fixed to the first flange and to the second flange by a bayonet catch.

10. The spool according to claim 1, wherein the connector comprises a plurality of ribs, the ribs extending in a radial direction and in an axial direction.

11. The spool according to claim 10, wherein the ribs are arranged equidistant in a circumferential direction.

12. The spool according to claim 10, wherein the ribs and the openings are arranged alternatingly in a circumferential direction.

13. The spool according to claim 10, wherein the connector comprises a first end portion connected to the first flange and a second end portion connected to the second flange, the ribs connecting the first end portion and the second end portion.

14. The spool according to claim 10, wherein outer end faces of the ribs define the winding surface for winding the filament about the winding axis in a circumferential direction.

15. The spool according to claim 10, wherein the connector is shaped one-piece.

16. A filament spool, comprising
the spool according to claim 1 and
a filament, the filament being winded on the spool.
